(19) United States
(12) Patent Application Publication
(10) Pub. No.: US 2014/0023997 A1
(43) Pub. Date: Jan. 23, 2014

(54) COMPUTER-IMPLEMENTED SYSTEM AND METHOD FOR ENGAGING AND EDUCATING BUSINESS-TO-BUSINESS SALES PARTNERS ON PRODUCTS AND SERVICES

(71) Applicant: MAARTI DEFONCE, Oceanport, NJ (US)

(72) Inventor: MAARTI DEFONCE, Oceanport, NJ (US)

(21) Appl. No.: 13/949,014

(22) Filed: Jul. 23, 2013

Related U.S. Application Data
(60) Provisional application No. 61/674,420, filed on Jul. 23, 2012.

(51) Int. Cl. G09B 19/00

(52) U.S. Cl. CPC G09B 19/00
USPC 434/107

(57) ABSTRACT

A computer-implemented method for engaging and dedicating sales partners is provided. In exemplary embodiments, the method may comprise, transmitting educational material to a user, the educational material comprising information related to at least one of a product and a service of an administrator; transmitting a test to the user and receiving test answers from the user; comparing the test answers with a predetermined set of correct answers, calculating a user proficiency, and determining if the user proficiency meets a predetermined standard; generating an alert notifying the administrator whether the user proficiency meets the predetermined standard and transmitting the alert to the administrator; transmitting secondary educational material to a user if the user proficiency does not meet the predetermined standard; and allocating a proficiency designation to the user if the user proficiency meets the predetermined standard and storing the proficiency designation in a database.

### CROSS-REFERENCE TO RELATED APPLICATIONS

The present application claims priority to U.S. Provisional Patent Application Ser. No. 61/674,420 entitled “Computer-Implemented System and Method For Engaging and Educating Business-To-Business Sales Partners On Products and Services,” filed Jul. 23, 2012, the disclosure of which is incorporated herein by reference in its entirety.

### BACKGROUND

1. Field of the Invention

Embodiments of the present invention are generally related to a computer-implemented system and method for engaging and educating business-to-business sales partners on products and services. More specifically, embodiments of the present invention relate a system and method of increasing product awareness in the educational, wholesale, education and retail industries by engaging the business-to-business sales partner or professional with an incentive-based program to become educated about a manufacturer's products.

2. Description of Related Art

Manufactures and/or distributes retail products desire to increase sales of their products or services by educating consumers about the uses, advantages, and benefits of the products or services. Manufacturers and/or distributors often do not have direct contact with consumers however, because the products or services are often sold directly to consumers through one or more sales partners. Sales partners have employees (e.g., sales managers and sales associates) who are responsible for selling the products and/or services of a retail/consumer product manufacturer through a wholesale or retail store. While employees of a sales partner and consumers may be generally aware of the various products manufactured by one company within a single genre of products, they may not understand the subtle differences between products of two competitors, or the importance of such differences. Typically the consumers may be educated about a product and/or service by speaking with a sales associate and/or sales manager of a sales partner or by accessing static product information websites. As such, the education of the consumer depends on the knowledge base and education of the employees of the sales partner. Training of the employees of the sales partner is typically controlled and/or managed by the sales partner. As such, manufactures and/or distributors have no control over the training of sales professionals and consumers.

Thus, a need exists for a system and method of increasing product awareness in the by engaging the business-to-business sales partner or professional with an incentive-based program to become educated about a manufacturer's products.

### SUMMARY

Embodiments of the present disclosure generally relate to a computer-implemented method for engaging and educating sales partners. In one embodiment, a computer-implemented method for engaging and educating sales partners may comprise at a server having one or more processors and memory storing one or more programs for execution by the one or more processors, transmitting educational material to a user, the educational material comprising information related to at least one of a product and a service of an administrator; transmitting a test to the user and receiving test answers from the user; comparing the test answers with a predetermined set of correct answers, calculating a user proficiency, and determining if the user proficiency meets a predetermined standard; generating an alert notifying the administrator whether the user proficiency meets the predetermined standard and transmitting the alert to the administrator; transmitting secondary educational material to a user if the user proficiency does not meet the predetermined standard; and allocating a proficiency designation to the user if the user proficiency meets the predetermined standard and storing the proficiency designation in a database

In another embodiment of the present disclosure, a computer-implemented method for engaging and educating sales partners may comprise at a client having one or more processors and memory storing one or more programs for execution by the one or more processors, receiving educational material from an administrator, the educational material comprising information related to at least one of a product and a service of the administrator; receiving a test and transmitting test answers from a user; receiving secondary educational material if a user proficiency does not meet a predetermined standard; and receiving a proficiency designation indication if the user proficiency meets the predetermined standard.

In yet another embodiment of the present disclosure, a system may comprise at least one server that may comprise one or more processors; and memory; wherein the at least one server is adapted to transmit educational material to a user, the educational material comprising information related to at least one of a product and a service of an administrator; transmit a test to the user and receive test answers from the user; compare the test answers with a predetermined set of correct answers, calculate a user proficiency, and determine if the user proficiency meets a predetermined standard; generate an alert notifying the administrator whether the user proficiency meets the predetermined standard and transmitting the alert to the administrator; transmit secondary educational material to a user if the user proficiency does not meet the predetermined standard; and allocate a proficiency designation to the user if the user proficiency meets the predetermined standard and store the proficiency designation in a database.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a system-level network diagram of a system for engaging and educating business-to-business sales partners on products and services in accordance with embodiments of the present invention;

FIG. 2 depicts a block diagram of a general computer system, which is capable of being used in connection with the system depicted in FIG. 1, in accordance with embodiments of the present invention;

FIG. 3 depicts a flow diagram illustrating a method of engaging and educating business-to-business sales partners on products and services in accordance with embodiments of the present invention;

FIG. 4 depicts a block diagram illustrating a system for engaging and educating business-to-business sales partners on products and services accordance with embodiments of the present invention; and

FIG. 5 depicts an exemplary client computer capable of being used with the system depicted in FIG. 1, in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a computer-implemented system and method for engaging and educating business-to-business sales partners on products and services. More specifically, embodiments of the present invention relate a system and method of increasing product awareness in the educational, wholesale, education and retail industries by engaging the business-to-business sales partner or professional with an incentive-based program to become educated about a manufacturer's products.

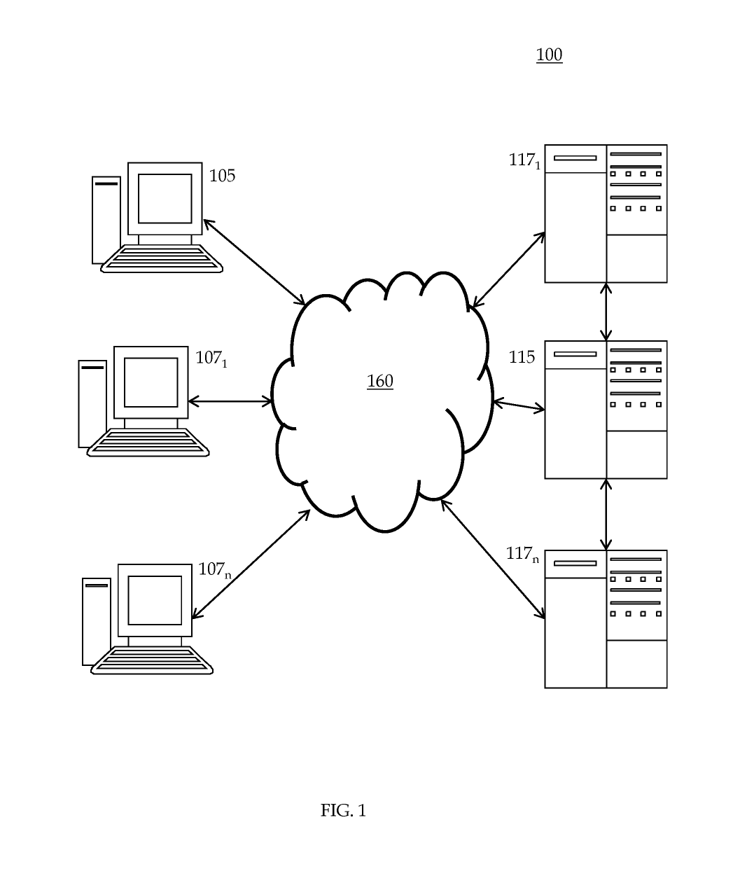

FIG. 1 depicts a system-level network diagram of a system for engaging and educating business-to-business sales partners on products and services in accordance with one embodiment of the present invention. The system 100 generally comprises at least a first client 105 and secondary clients 107₁ and 107₂, each in communication with an administrator, generally hosting a central server 115, through a network 160. Methods in accordance with one or more embodiments of the present invention take place over the network 160, which may comprise a global computer network, for example, the Internet.

Although FIG. 1 explicitly depicts three secondary users (labeled “User 2” 107₁, “User 3” 107₂, and “User N” 107_{N}), it should be appreciated that N represents any number of users feasible in accordance with embodiments of the present invention. For ease of reference, as used herein, each of the terms “second user” or “secondary user” may refer to any one or all of the clients 107₁, 107₂, and 107_{N} within the system 100. Likewise, although FIG. 1 explicitly depicts only one first client 105, there may be more than one first client 105 in accordance with certain embodiments of the present invention. That is, in certain embodiments, multiple users may perform the same or similar functions as the first client 105. As understood by embodiments of the present invention, a user may include any person, business or entity, capable of participating in the system and methods disclosed herein.

The first client 105 may generally comprise an entity or person that manufactures and/or distributes retail products or services through a sales partner. In many embodiments, the first client 105 may comprise a retail/consumer product manufacturer, having numerous products within a genre of products, each intended for a different consumer market. An exemplary first client 105 may comprise a skin care company, a fragrance company, a hair product company, a cosmetics company, a clothing company, a footwear company, an appliance company, an electronics company, a textiles company, an automobile company, a educational/pharmaceutical company, a food service company, or the like.

The secondary clients 107 may generally comprise an entity or entities, or persons, constituting the sales partner of the first client 105 as described above. In many embodiments, the secondary clients 107 comprise the employees (e.g., sales managers and sales associates) of a sales partner entity of the first client 105, who are responsible for selling the products of a retail/consumer product manufacturer through a wholesale or retail store. The sales partner entity may generally comprise a retail store, a virtual store (i.e., available through a computer network), a wholesale store/club, or the like. In alternative embodiments, the secondary clients 107 comprise end users and/or customers of the sales partner or first user. Often, the secondary clients 107 are generally aware of the various products manufactured by one company within a single genre of products, but do not understand the subtle differences therein in their entirety, or the importance of such differences.

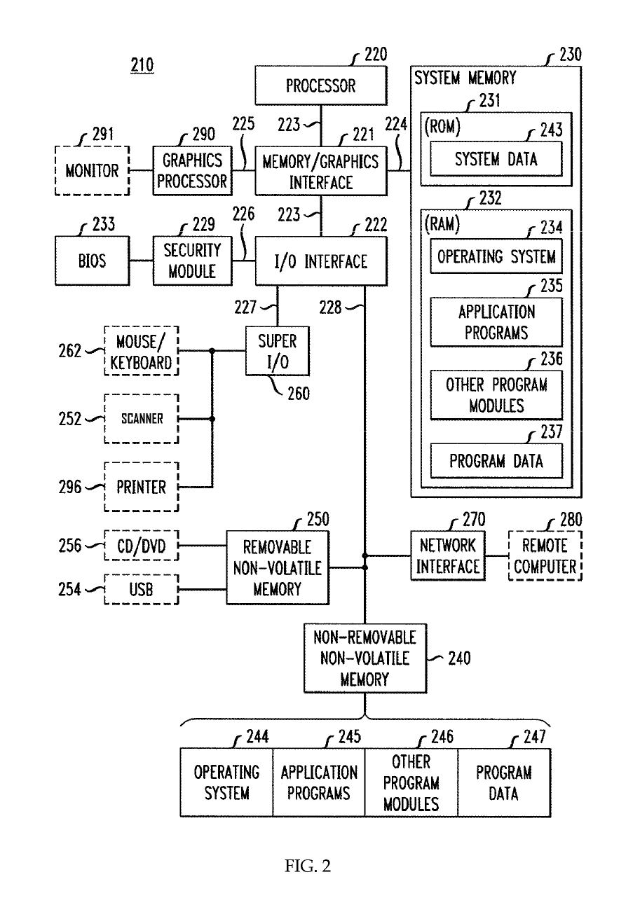

In a basic exemplary embodiment, within the system 100, the first client 105, and/or any of the secondary clients 107, may be capable of transmitting data to and from an administrator using a communication device. The communication device in the context of the present application may include, but is not limited to, a personal computer, a portable computer, a handheld computer, a cellular phone, a smart phone, a digital tablet, a laptop computer, an Internet appliance, an Apple iPhone, a Blackberry device, a Personal Data Assistant (PDA) or the like, or may generally include a general purpose computer, as discussed below with respect to FIG. 2.

The administrator generally comprises a server 115, which may further host an accessible data portal. In alternative embodiments, the server 115 may be located on a third party location (e.g., a server farm, or cloud), or at a location of the first client 105, or any one or more of the secondary clients 107. The accessible data portal, which may be accessible to the first client 105 and any of the secondary clients 107, communicates with each user through the network 160. The accessible data portal may comprise any number of security measures to provide a reasonably secure system, suitable for embodiments of the present invention. The accessible data portal may further comprise a graphical user interface (GUI) through which any of the first client 105 or secondary clients 107 may access the server 115.

Methods in accordance with embodiments of the present invention may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 (“Wi-Fi”) protocol, cellular data protocol (e.g., EDGE, CDMA, TDMA, GSM, LTE), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

Although FIG. 1 depicts two secondary clients 107₁ and 107n, it should be appreciated that “n” represents any number of clients feasible in accordance with embodiments of the present disclosure. For ease of reference, as used herein, the term “client” may refer to any one or all of the clients, 105, 107₁, and 107ₙ within the system 100. That is, in certain embodiments, multiple clients may perform the same or similar functions. For ease, one client 105 will be referred to herein, however in exemplary embodiments, more than one client 105 may be included in the system 100.

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The client 105 may generally comprise a communications device, such as a computer. In a basic exemplary embodiment, within the system 100, the client 105 may be capable of transmitting data to and from a host server 115. The host server 115 may host an accessible data portal (e.g., a website or the like). The accessible data portal, which may be accessible to the client 105, may communicate with the client 105 through the network 160. The accessible data portal may comprise any number of security measures to provide a reasonably secure system, suitable for embodiments of the present disclosure. The accessible data portal may further comprise a graphical client interface (GUI) through which a client 105 may access the server 115.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The server 115 may also comprise a database or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer, for example, as shown in the form of a computer 210 depicted in FIG. 2.

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

FIG. 2 depicts a block diagram of a general computer system, which is capable of being used in connection with the system depicted in FIG. 1, in accordance with embodiments of the present disclosure. As appreciated by embodiments of the present disclosure, mobile devices, such as mobile telephones, tablets, netbooks, or the like, may be utilized instead a general computer 210 for embodiments of the present disclosure. However, it is also appreciated there is a significant similarity in core components between a mobile device and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD), blue-ray or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any security technology suitable for embodiments disclosed herein.

A super input/output chip 260 may be used to connect to a number of peripherals, such as a scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A client may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure.

It is understood by embodiments of the present disclosure that a computer, such as the one depicted in FIG. 2, may be connected to a computer network or system. A computer network may include the Internet, a global computer network, an internal computer network, dedicated server networks, or the like.

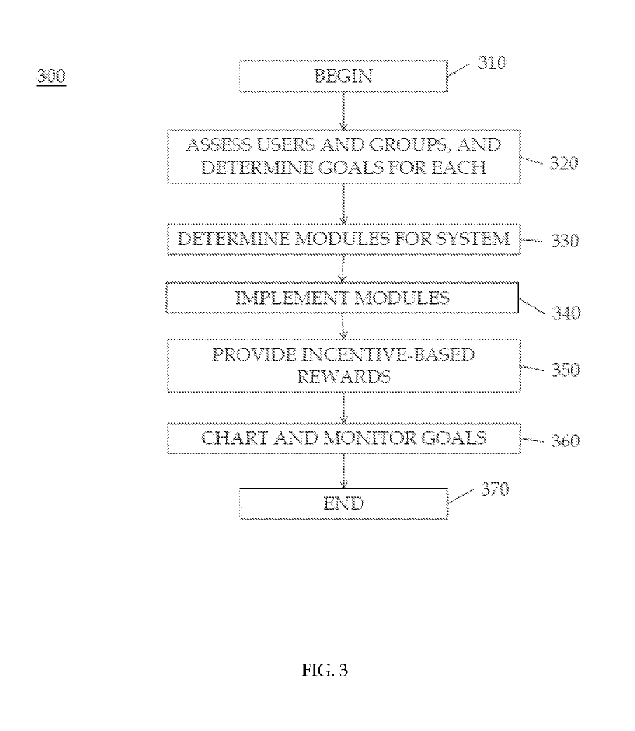

FIG. 3 depicts a flow diagram illustrating a method of engaging and educating business-to-business sales partners on products and services in accordance with one exemplary embodiment of the present invention. The exemplary method 300 begins at step 310 by establishing a system infrastructure such as the one depicted in FIG. 1. In many embodiments, the system infrastructure is established when a first user engages an administrator to implement the systems and methods as described herein.

At step 320, the administrator and the first user work together to assess secondary users and groups thereof, and determine goals for each secondary user and/or group to be achieved through the systems and methods herein. In many embodiments, the assessment of secondary users and groups thereof may be evaluating the respective positions of personnel within a chain store. For example, the assessment may comprise determining upper level management, regional management, store management, and associates thereunder (and any hierarchy of positions therein.) In other embodiments, particularly those involving large retail chains, assessments may also carve out particular positions or knowledge areas of each secondary users, e.g., skin care specialists vs. footwear experts.

Also as part of this step, goals may be established for each of the secondary users or groups thereof to be achieved through the systems and methods herein. In many embodiments, the goals may comprise a desirable overall value or score with regard to performance of the users of the system. For example, in some embodiments, the systems and methods herein track product knowledge in forms of variables, such as, comprehension (i.e., general understanding), application (i.e., specific uses of a product) and analysis (i.e., analytical ability to assess situation and provide proper solution). In addition, such goals may include a percentage of users that achieve rated scores within the system, such as “below growth,” “above growth,” “above proficiency,” or “below proficiency.” In alternative embodiments, any form of goal setting suitable for embodiments of the present invention may be utilized.

At step 330, the educational modules to be utilized within the system are selected by the administrator and/or the first user. In many embodiments, the educational modules comprise a form of interactive software to be implemented by the administrator on a mobile device, computer, or other electronic communication means of a secondary user to engage the secondary user in the systems and methods herein. Generally, the educational modules comprise a form of interactive software presenting the secondary user with the ability to learn about a particular product or set of products. For example, in one embodiment, the educational modules comprise a form of a multiple choice game (e.g., Jeopardy, trivia, pick outcome, true/false, general knowledge tests, etc.), a survey (e.g., opinion polls, etc.), and/or an alternative form of a game (e.g., word association, memory, crossword puzzles, “what's different?,” etc.), or the like. In many embodiments, any number of educational modules may utilized.

At step 340, once the educational modules for a particular application or system are selected, the educational modules may be implemented within the secondary users or groups thereof. In many embodiments, the implementation of the educational modules comprises requiring each of the secondary users to “sign up” and “opt-in” with the system, through the administrator. In some embodiments, the secondary users may log into a website hosted by the administrator and create a user account. In other embodiments, the secondary users may download a mobile application for a mobile device. In further embodiments, the secondary users may be pre-signed up by their employer as a requirement of working with the first user. In yet additional embodiments, the secondary user may merely opt-in to the educational modules, and voluntarily utilize the educational module to enhance his or her performance and knowledge.

In many embodiments, the secondary users may be required, as part of their employment, to utilize the educational modules on a regular and periodic basis. For example, in one embodiment, the secondary users may be required to log a certain amount of time with the educational module per month/week. In another embodiment, the secondary users may be required to earn a certain score within the educational module, for example, if the educational modules have point totals for correct responses, the secondary users may be required to cross a particular threshold. In yet a further embodiment, the secondary users may be required to utilize the educational module until the system determines a particular user has a sufficient proficiency in the subject matter of the educational module, such that no further use is required.

At optional step 350, the secondary users may optionally be motivated to utilize the educational modules via an incentive-based rewards program associated therewith. In such embodiments, the secondary users may accumulate points via the use of the educational module. For example, by logging a certain amount of time, responding correctly to inquiries, showing improvement in one or more areas of established goals, or the like, the user may accumulate any number of points towards a rewards program. In many embodiments, the rewards program may be an internal program to a company, whereby a secondary user may receive products, gift cards, vacation time, bonuses, or the like, in exchange for points. In other embodiments, the points accumulated may be redeemable through a third party rewards program, having set point value for any variety of goods and/or services. Whereas such general types of rewards programs are generally known, no further discussion thereof is necessary.

At step 360, the administrator and/or first user may monitor and chart the performance of the secondary users of the system in view of the projected goals originally established. For each of the areas of goals set, progress may be shown over any period of time, and any number of secondary users or groups thereof. By providing such analytical data, the system enables the administrator to determine the greatest areas of success to promote in further applications, and it enables the first user to monitor the increased product knowledge held by its sales partner, which it turn leads to higher sales volume. The method 300 ends at step 370.

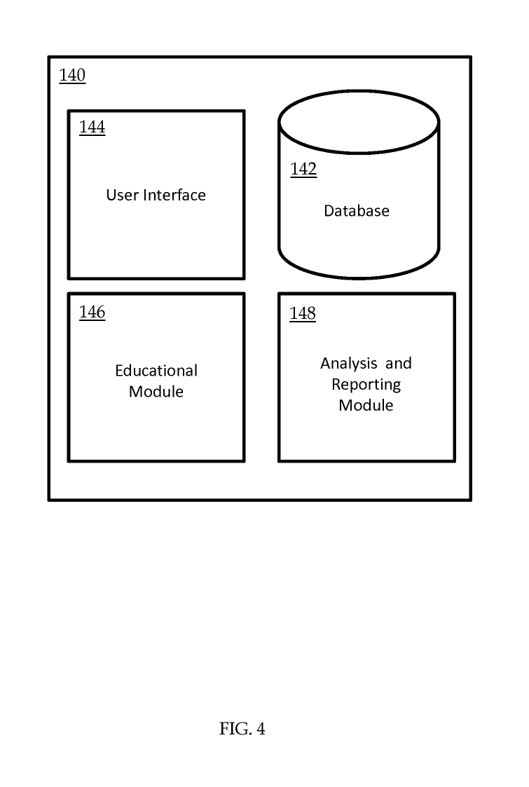

FIG. 4 depicts a block diagram illustrating an education system 140 for engaging and educating business-to-business sales partners on products and services accordance with embodiments of the present invention. The education system 140 may generally comprise computer executable software and/or instructions configured to perform the functionality of the systems and methods disclosed herein. The education system 140 may be stored on a server, on a local computing device, on a mobile communications device, and/or the like. The education system 140 may comprise a database 142, an interface module 144, an educational module 146, an analysis and reporting module 148, and/or the like. In accordance with exemplary embodiments of the present invention, any module may be merged and/or combined with any other module. In some embodiments, additional or fewer modules than those depicted in FIG. 3 may be included.

In exemplary embodiments, the education system 140 may be configured to engage and/or education business-to-business sales partners on products and services. The education system 140 may be adapted to transmit educational information to one or more users, receive testing data from the one or more users, analyze testing data, allocate rewards to the user based on the analysis, generate alerts if the analysis meets a predetermined condition, store at least a portion of the testing data and/or the analysis, and present a report to an administrator and/or user. In some embodiments, the education system 140 may be configured to provide real-time or substantially real-time testing data, rewards data, and/or educational data to users upon request, at predetermined intervals, upon the occurrence of an event, and/or the like. In exemplary embodiments, the term “user” may generally refer to any party provided with access to the systems and methods in accordance with embodiments of the present invention. For example, a user may comprise a manufacturer, a distributor, a consumer, a sales manager, a sales associate, and/or the like.

In exemplary embodiments, the interface module 144 may be adapted to provide the user with a means for interacting with the education system 140. The interface module 144 may be adapted to present a graphical user interface (GUI) to the user, the GUI adapted to allow users to input, view, and interact with the education system 140. In some embodiments, the interface module 144 may be adapted to present educational information to a user via a display on a computer, a tablet, a mobile device, a laptop, a touchscreen device, and/or the like. The interface module 144 may also be adapted to provide an opportunity to register a user account for accessing the education system 140. User accounts may be restricted to authorized personnel and a verification of a user's identity, such as a social security number or an employee ID number, may be required. In some embodiments, user account requests must be approved by an administrator of the education system 140 and/or may only be created by an administrator. The interface module 144 may be adapted to allow a user to run a search query on data stored in the database 142. The interface module 144 may also be adapted to allow a user to enter data into the educational module 146.

In accordance with exemplary embodiments of the present invention, the interface module 144 may also allow a user to access educational and/or testing data generated, filtered, and/or stored by the analysis and reporting module 148. The interface module 144 may be adapted to allow the user to run a report on the data contained in the database 142 with the analysis and reporting module 148 upon request, at predetermined intervals, or upon the occurrence of an event. For example, a user may access educational data upon running a report request with the interface module 144. The interface module 144 may also be adapted to transmit and/or display alert messages to the user when an event occurs and/or an alert is received from the analysis and reporting module 148. An event that triggers an alert may comprise, for example, data that indicates a user has passed a test, failed a test, exceeded the requirements of a test, gained a certification, passed a course, failed a course, provided incorrect data, provided correct data, and/or the like.

In exemplary embodiments, alerts may be presented to the user via a display on a computer or electronic device, via a text or SMS message, via an automated phone call, via email, via an auto-generated letter via postal mail. When an alert is generated, it may be sent to multiple parties. For example, if the analysis and reporting module 148 determines that an event has occurred and an alert should be generated, an alert may be generated and sent via one or more communication means to a user, for example, a manufacturer, a distributor, an sales associate, a sales manager, and/or the like. The interface module 144 may also be adapted to allow users who are granted sufficient permissions by the administrator to add, delete, and/or modify data saved in the system. Certain data may be completely restricted from modification or deletion, however, such as data received from educational tests. The interface module 144 may also be customized by a user and/or an administrator. For example, the interface module 144 may be customized to display educational data and or tests in a customized visual format, such as in the form of a game show, a trivia game, and/or the like. The interface module 144 may also be customized to display educational data at certain time intervals, upon the occurrence of an event (e.g., an incorrect answer or a failed test), or upon request of a user and/or administrator.

In accordance with exemplary embodiments of the present invention, the educational module 146 may be adapted to receive data from a device, such as a computing device or mobile communications device, and/or the like. In exemplary embodiments, educational data may comprise real-time data regarding the products and/or services of a manufacturer and/or distributor. IN some embodiments, educational data may comprise testing data collected from a user in response to a test, and/or the like. In some embodiments, if the educational and/or testing data may be transmitted to the analysis and reporting module 148. In accordance with exemplary embodiments, the database 142 may be adapted to store all educational data in accordance with the present invention.

In accordance with exemplary embodiments of the present invention, the analysis and reporting module 148 may be adapted to analyze educational data collected by the educational module. The analysis and reporting module 148 may be adapted to apply one or more algorithms or sets of rules against data collected by the educational module 146. The analysis and reporting module 148 may be adapted to find and/or identify data that indicates a user is knowledgeable or is not knowledgeable about a specific product and/or service. In some embodiments, if the user is knowledgeable, rewards, such as rewards points, may be allocated to the user and stored in the database. In some embodiments, rewards may be allocated to a user for events such as interacting with the system 140, logging in, spending a predetermined time actively accessing the system 140, answering a predetermined number of questions, completing a test, and/or the like. In some embodiments, rewards may be redeemed for products, services, discounts, and/or the like and may be transmitted to other users, or the like.

The analysis and reporting module 148 may be adapted to flag and identify educational deficiencies and/or proficiencies to a user and/or administrator via an alert, a report, or upon request from the user and/or administrator. The analysis and reporting module 148 may compare the collected educational data with predetermined criteria for indicating knowledge proficiency. Predetermined criteria may generally be set by manufacturers, distributors, sales managers, and/or the like. If the collected educational data does not fall within the predetermined criteria, an indication that educational deficiency is present may be generated and an alert reporting the deficiency may be generated. The analysis and reporting module 148 may be adapted to notify the user and/or administrator via the interface module 144. The analysis and reporting module 148 may also be adapted to generate reports and/or alerts comprising a summary of all users, administrators, and/or the like. The reports and/or alerts may be transmitted and/or displayed to the user and/or administrator via text or SMS message, mobile communication device, email, postal mail, a report generated on the display of a computing device, and/or the like.

Embodiments of the present invention may also relate to systems and methods of increasing knowledge related to medical conditions, or the like. For example, the system may comprise a system for engaging and educating patients by businesses, hospitals, health systems, doctors and/or the like. In some embodiments, a patient may be provided with an initial test for testing a patient's knowledge on a particular disease. For example, the patient may be provided with dietary related testing questions. The patient's answers may be compared to ideal answers for a specific condition, and if the patient's answers differ by a predetermined amount, the patient may be provided with educational content by the system. A post-assessment may also be provided for assessing effectiveness of the content and/or the results of a particular recommended diet provided by the educational content, and/or the like.

In exemplary embodiments, a system may be adapted to provide knowledge analysis, risk analysis, and/or the like. By way of example, healthcare providers, such as doctors, hospitals, clinics, and/or the like, may wish to contact patients after treatment or prevention of a medical condition and receive assessment data. A system in accordance with embodiments of the present invention may be adapted to provide a correlation between readmission rates, or the like, and knowledge, such as dietary knowledge, or the like. In exemplary embodiments, the patient may be contacted after treatment and/or preventative measures have been administered and/or recommended. The patient may be provided with educational information adapted to decrease the likelihood or risk of readmission and/or occurrence of a medical condition. The patient may be provided with a test to assess knowledge, treatment plan compliance, and/or the like. A system in accordance with exemplary embodiments may be adapted to identify certain patients as high risk by determining that certain patients do not meet threshold knowledge requirements. This determination may be made, for example, by calculating the percentage of correct answers a patient submits on a test and comparing it with a threshold percentage, or the like. If it is determined that a patient is at a higher risk of a medical condition, the patient and/or their healthcare provider may be notified and/or the patient may be provided with further educational material. Further testing at later dates/times may also be scheduled by the system, for example, at predetermined intervals. Analysis of risk provided by the systems in accordance with embodiments of the present invention may provide data to healthcare providers that may decrease the risk of readmission of a patient and/or reoccurrence of a medical condition.

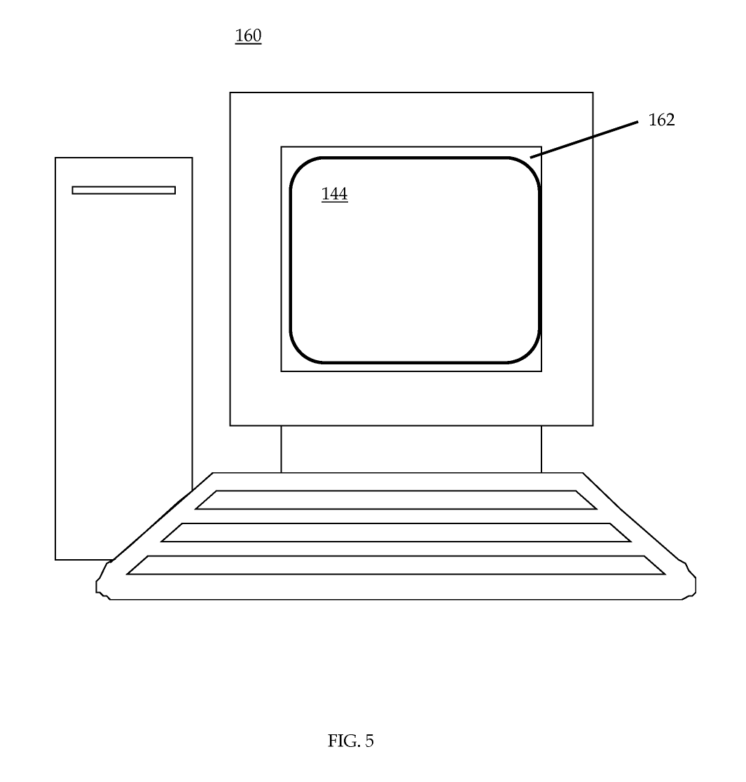

FIG. 5 depicts an exemplary client computer capable of being used with the system depicted in FIG. 1, in accordance with embodiments of the present invention. In exemplary embodiments, the client computer 160 may comprise a display 162. The display 162 may be adapted to display at least an interface 154. In exemplary embodiments, the functionality and appearance of the display may be determined by an interface module 144. The interface 154 may be adapted to display any data and analysis collected, stored, and/or analyzed by a system in accordance with embodiments of the present invention. Although a client computer 160 is depicted as a personal computer in FIG. 5, any computing device may be used. By way of example, a mobile phone, a tablet computer, a laptop computer, and/or the like may be used, to name a few.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. A computer-implemented method for engaging and educating sales partners, the method comprising:
at a server having one or more processors and memory storing one or more programs for execution by the one or more processors:
transmitting educational material to a user, the educational material comprising information related to at least one of a product and a service of an administrator;
transmitting a test to the user and receiving test answers from the user;
comparing the test answers with a predetermined set of correct answers, calculating a user proficiency, and determining if the user proficiency meets a predetermined standard;
generating an alert notifying the administrator whether the user proficiency meets the predetermined standard and transmitting the alert to the administrator;
transmitting secondary educational material to a user if the user proficiency does not meet the predetermined standard; and
allocating a proficiency designation to the user if the user proficiency meets the predetermined standard and storing the proficiency designation in a database.

2. The method of claim 1, further comprising:
allocating a reward allocation to the user if the user proficiency meets the predetermined standard and storing the reward allocation in a database.

3. The method of claim 2, wherein the reward allocation may comprise points that may be redeemed for at least one of a product, a service, monetary compensation, vacation time, and a discount.

4. The method of claim 1, wherein the test may be adapted to evaluate comprehension, application, and analysis of at least one of a product and a service.

5. The method of claim 1, further comprising:
receiving a set of goals from the administrator, the set of goals comprising a number of proficiency designations;
transmitting the set of goals to the user; and
transmitting a goal satisfaction indication to at least one of the administrator and the user if the user satisfies the set of goals, the goal satisfaction indication comprising a notification the user has satisfied the set of goals.

6. The method of claim 1, wherein the administrator comprises at least one of a manufacturer and a distributor.

7. The method of claim 1, wherein the user comprises at least one of a sales associate, a group of sales associates, a sales manager, and a group of sales managers.

8. The method of claim 1, wherein the test comprises at least one of a multiple choice test, a multiple choice game, a survey, a puzzle, a word association game, and a crossword puzzle.

9. The method of claim 1, wherein the user proficiency comprises a percentage of correct answers.

10. The method of claim 1, wherein the predetermined standard comprises a threshold percentage; and
wherein the predetermined standard is set by the administrator.

11. A computer-implemented method for engaging and educating sales partners, the method comprising:
at a client having one or more processors and memory storing one or more programs for execution by the one or more processors:
receiving educational material from an administrator, the educational material comprising information related to at least one of a product and a service of the administrator;
receiving a test and transmitting test answers from a user;
receiving secondary educational material if a user proficiency does not meet a predetermined standard; and
receiving a proficiency designation indication if the user proficiency meets the predetermined standard.

12. The method of claim 11, further comprising:
receiving a reward allocation indication if the user proficiency meets the predetermined standard.

13. The method of claim 12, wherein the reward allocation may comprise points that may be redeemed for at least one of a product, a service, monetary compensation, vacation time, and a discount.

14. The method of claim 11, wherein the administrator comprises at least one of a manufacturer and a distributor.

15. The method of claim 11, wherein the user comprises at least one of a sales associate, a group of sales associates, a sales manager, and a group of sales managers.

16. A system comprising at least one server, the server comprising:
one or more processors; and
memory;
wherein the at least one server is adapted to:
transmit educational material to a user, the educational material comprising information related to at least one of a product and a service of an administrator;
transmit a test to the user and receive test answers from the user;
compare the test answers with a predetermined set of correct answers, calculate a user proficiency, and determine if the user proficiency meets a predetermined standard;
generate an alert notifying the administrator whether the user proficiency meets the predetermined standard and transmitting the alert to the administrator;
transmit secondary educational material to a user if the user proficiency does not meet the predetermined standard; and
allocate a proficiency designation to the user if the user proficiency meets the predetermined standard and store the proficiency designation in a database.

17. The system of claim 16, wherein the at least one server is adapted to:
allocate a reward allocation to the user if the user proficiency meets the predetermined standard and store the reward allocation in a database.

18. The system of claim 17, wherein the reward allocation may comprise points that may be redeemed for at least one of a product, a service, monetary compensation, vacation time, and a discount.

19. The system of claim 16, wherein the at least one server is adapted to:
receive a set of goals from the administrator, the set of goals comprising a number of proficiency designations;
transmit the set of goals to the user; and
transmit a goal satisfaction indication to at least one of the administrator and the user if the user satisfies the set of goals, the goal satisfaction indication comprising a notification the user has satisfied the set of goals.

20. The system of claim 16, wherein the predetermined standard comprises a threshold percentage; and
wherein the predetermined standard is set by the administrator.
